(19) United States
(12) Patent Application Publication
(10) Pub. No.: US 2012/0052836 A1
(43) Pub. Date: Mar. 1, 2012

(54) METHOD AND SYSTEM FOR PERSONAL EMERGENCY MOBILE COMMUNICATION

(76) Inventors: Richard Michael Buratti, Austin, TX (US); Christi Lyn Davidson, Austin, TX (US)

(21) Appl. No.: 13/216,911

(22) Filed: Aug. 24, 2011

Related U.S. Application Data
(60) Provisional application No. 61/377,251, filed on Aug. 26, 2010.

(51) Int. Cl. H04W 4/02; H04W 4/00

(52) U.S. Cl. 455/404.2; 455/404.1

(57) ABSTRACT

A method and system for personal emergency mobile communications includes providing a mobile communication device having a personal emergency button (PEB) and associated functionality, which may be powered by a secondary power source. Activation of the PEB by a user may cause a wireless PEB notification to be sent to a PEB service provider. Based on the PEB notification, the service provider may identify the user, the user's location, and retrieve user emergency data. The mobile communication device may further be configured to send and/or retain forensic evidence, such as image data, audio data, or other data associated with the user's situation.

This application claims priority to U.S. Provisional Patent Application No. 61/377,251, entitled Method and System for Personal Emergency Mobile Communication, filed Aug. 26, 2010, which is incorporated by reference herein.

### BACKGROUND

1. Field of the Disclosure

The present disclosure relates to mobile communication services and, more particularly, to a personal emergency mobile communication service.

2. Description of the Related Art

In the case of an emergency, many users of mobile communication services rely on their mobile communication devices. An emergency notification using a conventional mobile communication device, such as a cellular telephone, may involve numerous conditions and actions that may hinder effective usage during certain types of emergencies.

### SUMMARY OF THE INVENTION

Currently, contacting emergency personnel on current mobile communications devices requires that the device be on, the number (911) be dialed correctly, and that the individual be sufficiently coherent and located in an environment that would permit the individual to speak to an operator. Emergencies, however, rarely allow such conveniences. If an individual is in imminent danger or in a situation where they cannot speak (freely or otherwise) or see their mobile communications device, calling 911 may be impossible Likewise, if an individual has been abducted, it is not likely they will know their current location.

In one embodiment, a one-push Personal Emergency Button (PEB) on mobile communications devices is disclosed that when pressed or activated for a designated duration (in one embodiment, pressed for a minimum of three seconds) will send a “mayday” signal to authorities (monitoring group) and transmit the GPS location of the caller/device and other important data. In another embodiment, the PEB(s) may be recessed and easily findable on the device when running a finger over the device even in total darkness and in panic situations. In one embodiment, the PEB is not an application download, but is a part of the hardware itself. In this embodiment, when the PEB is pressed for the designated duration, the device, if off, would turn on and would and send the signal. The purpose is to indicate an emergency when the user can't say anything and can't have anyone say anything to him or her. Thus, enabling others to know the user has an emergency and to further know the user's location and to be able to follow the user.

In one embodiment, when the PEB is pushed and held for at least three seconds, the device would send an imminent danger notification call to the 24/7 monitoring agency. This notification may be in multiple forms including, but not limited to, cell phone call, internet message, text message, or any other electronic form transmittable by the mobile communications device and receivable by the monitoring group. If the mobile communications device is turned off, properly activating the PEB will turn on the device and send the imminent danger notification. In one embodiment, activating the PEB would override all other activities on the mobile communications device instantly. In such embodiment, if a call, text, internet, application, or other use were in progress, it would immediately terminate in favor of the PEB and its functions. When the notification is received by the monitoring agency, the GPS location of the device and user will be known and the appropriate local emergency personnel can be dispatched to help. The monitoring agency will be able to track the movement of the device and keep applicable authorities and other personnel notified. In one embodiment, the monitoring agency will know there is to normally be no verbal contact with the user because of the dangerous situation most likely precipitating the call. The monitoring agency's computer screen or display may automatically pull up the user's “In Case of Emergency” (ICE) information which may have a photograph of the user, vital statistics, and personal emergency contacts. The monitoring agency may immediately notify the emergency personnel (appropriate authorities) closest to the GPS location of the user. In one embodiment, when the PEB is activated, the mobile communications device is prevented from being turned off. In one embodiment, when the PEB is activated, neither the number nor the name of the monitoring group called will appear in the display or outgoing calls list. In another embodiment, once activated, the only way to reset the mobile communications device to its normal operating mode will be by the monitoring group upon satisfaction that the personal emergency event has been resolved. In additional embodiments, when the PEB is activated it may activate other features in the communications device that will aid the emergency authorities. For example, (i) when activated, the volume on the mobile communications device's microphone may go to the highest level so the monitoring agency can hear what is going on to assist as necessary; (ii) when activated, all nonessential features of the mobile communications device may go into sleep mode to preserve battery life for PEB and microphone; (iii) when activated, the mobile communications device's visual capabilities (still pictures and/or video) may be activated and images transmitted to the monitoring group; (iv) when activated, the mobile communications device should be able to retain any forensic evidence that might be beneficial; and (v) when activated, the mobile communications device may send a text message, such as “I am in imminent danger” or similar message, to the emergency authorities and to other emergency contacts listed as part of the ICE (In Case of Emergency) information. In a further embodiment, a separate internal battery within the communications device powers the PEB(s) switch mechanism after the main battery is removed from the mobile communications device or the main battery loses its charge. In this way the GPS signal will still be transmitted. If the person is a minor, the Amber alert may also be activated and information downloaded to police car monitors and local authorities.

### BRIEF DESCRIPTION OF THE DRAWINGS

FIG. 1 is a block diagram of selected elements of an embodiment of a mobile communication system;

FIG. 2 is a block diagram of selected elements of an embodiment of a mobile communication device;

FIG. 3 is a flow chart describing selected elements of an embodiment of a method for personal emergency mobile communication;

FIG. 4 is a block diagram of selected elements of an embodiment of a computing device; and

FIG. 5 is a flow chart describing selected elements of an embodiment of a method for personal emergency mobile communication.

### DESCRIPTION OF THE EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

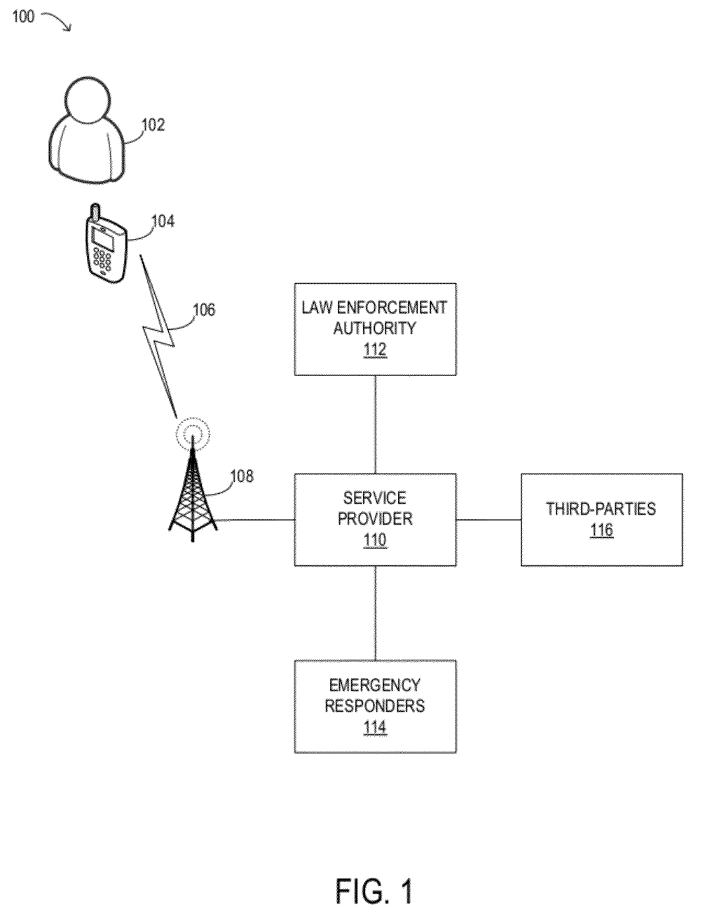

Referring now to FIG. 1, a block diagram of selected elements of mobile communication system 100 is illustrated. Elements in FIG. 1 are drawn figuratively for illustrative purposes and are not drawn to scale or to any particular perspective. Mobile communication system 100 depicts interaction between user 102 and service provider 110 for the purpose of communicating a personal emergency experienced by user 102 and to which a commensurate response is desired.

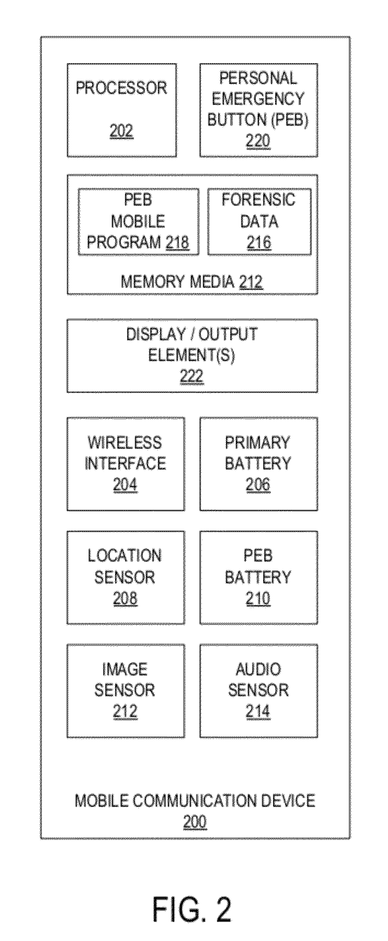

In FIG. 1, user 102 may be in possession of mobile user device 104, which may be a personal mobile communication device associated with user 102. Examples of mobile user device 104 may include personal data assistants (PDA), smart phones, portable media players, and cellular phones, among others (see also FIG. 2). Mobile user device 104 may be equipped with a personal emergency button along with associated components and functionality (not explicitly shown in FIG. 1). In particular embodiments, the PEB may be implemented as a physical (i.e., hardware) element on an exterior surface of mobile user device 104. In case of an emergency (referred to herein as a “PEB event”), user 102 may activate the PEB on mobile user device 104 in order to make use of PEB services provided by service provider 110, as will be described in further detail below.

As shown in FIG. 1, mobile user device 104 may communicate using wireless network 106 with wireless network provider 108, which may provide wireless network 106 over various geographic areas and markets (not shown in FIG. 1). It is noted that user 102 as well as mobile user device 104 may be associated with a particular physical location when user 102 activates the PEB. Wireless network provider 108 may be configured to track and report the physical location of mobile user device 104 (which may be assumed to also represent the location of user 102) using any one of a number of means. For example, wireless network provider 108 may be configured to triangulate a signal using wireless network 106 to determine a location for mobile user device 104. In another example, mobile user device 104 may include a location sensor (see also FIG. 2) which may transmit location information to wireless network provider 108.

In FIG. 1, wireless network provider 108 is shown in communication with service provider 110. In the exemplary system architecture of mobile communication system 100, service provider 110 may receive PEB messages from user 102 via wireless network provider 108 when user 102 activates the PEB on mobile user device 104, that is, when a PEB event occurs. In certain implementations, wireless network 106 may provide wireless access to a public network, such as the Internet, to mobile user device 104, such that communications between mobile user device 104 and service provider 110 are provided using a network protocol, such as the transmission control protocol/Internet protocol (TCP/IP). It is noted that wireless network provider 108 may operate wireless network 106 independently from service provider 110. Accordingly, wireless network provider 108 may represent one of a number of different wireless network providers with which service provider 110 may communicate to provide PEB services to reach a large number of users, such as user 102. Service provider 110 may be a third party monitoring agency such as OnStar, LLC. In other system architectures of mobile communication system 100, wireless network provider 108 may, in addition to operating wireless network 106, also serve as service provider 110.

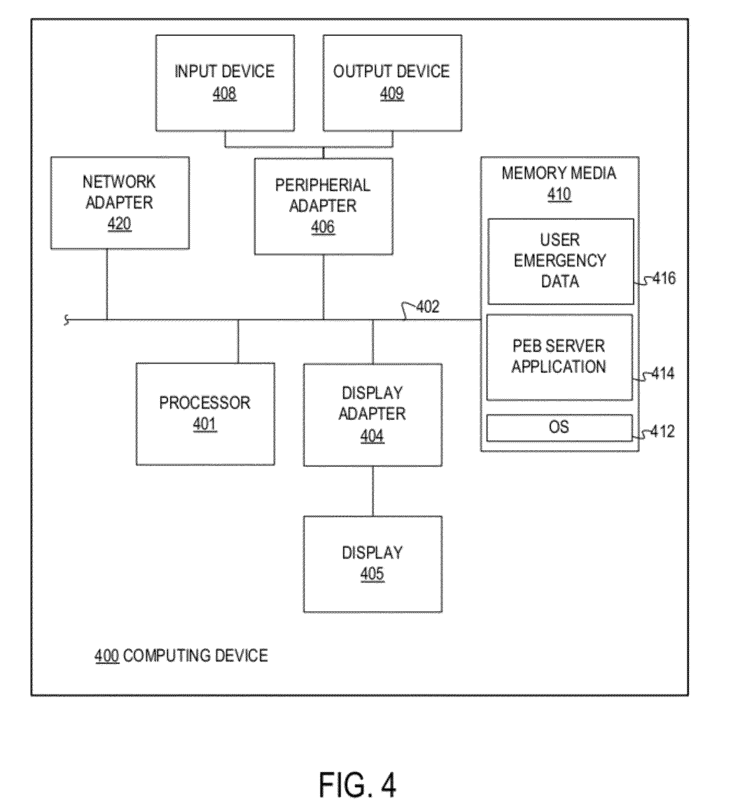

As depicted in FIG. 1, service provider 110 may be configured to communicate with other entities, such as law enforcement authority 112, emergency responders 114, and third-parties 116. Law enforcement authority 112 may represent the branches or divisions (i.e., organs) of a local, regional, state or federal law enforcement agency. Specifically, depending on the nature of the PEB message received from user 102 and/or other information associated with the PEB event, service provider 110 may be configured to establish contact with a particular organ of law enforcement authority 112 for the purpose of notification of the PEB event. The selection of the particular organ of law enforcement authority 112 by service provider 110 may be based on jurisdiction, the location of mobile user device 104, the type of PEB event, and/or user emergency data 416 (see FIG. 4) that was previously collected for describing user 102, including preferences of user 102 with respect to PEB services. For example, when user 102 is known to be underage (i.e., a minor under the law), then service provider 110 may be configured to contact governmental agencies responsible for searches and alerts for missing children (e.g., Amber Alert and/or similar programs). Emergency responders 114 may similarly represent the organs of emergency response services or first-responder services, such as ambulances, paramedics, fire-fighters, and/or police. In particular, service provider 110 may be configured to select a particular organ of emergency responders 114 based on a location of mobile user device 104, along with other pertinent information associated with the PEB event. Third-parties 116 may represent individuals or entities that user 102 may have selected for notification in case of a PEB event, and for whom contact information may be included in user emergency data 416 (see FIG. 4). For example, user 102 may designate relatives, friends, or business contacts, such as an employer contact, as third-parties 116.

In operation of mobile communication system 100, user 102 may activate the PEB at mobile user device 104 when a PEB event occurs. Mobile user device 104 may be configured to automatically take certain actions when the PEB is activated. For example, mobile user device 104 may send a PEB message, including an identifier for user 102, to service provider 110 via wireless network 106. Mobile user device 104 may also send additional information, such as a location of mobile user device 104, or other sensor inputs (i.e., audio, image, etc.) to service provider 110. Service provider 110, upon receiving the PEB message, may identify and retrieve user emergency data 416 (see FIG. 4) for user 102. In certain instances, service provider 110 may display user emergency data 416 to an operator for manual processing associated with the PEB event. Thus, either automatically or manually, based on information in user emergency data 416, law enforcement authority 112, emergency responders 114, and/or third-parties 116 may be notified by service provider 110 of the PEB event, of the identity of user 102, of the location of mobile user device 104, and such other information as available from user emergency data 416 (see FIG. 4) for user 102. In addition, service provider 110 may continue to receive information from mobile user device 104 as the PEB event persists, and may continue to record and/or provide such information to law enforcement authority 112, emergency responders 114, and/or third-parties 116. When service provider 110 receives an indication that user 102 is no longer experiencing the PEB event, service provider 110 may terminate the internal processing and communication associated with the PEB event.

Turning now to FIG. 2, a block diagram of selected elements of an embodiment of mobile communication device 200 is illustrated. Mobile communication device 200 includes functional elements that may be included in mobile user device 104 (see FIG. 1). Functional elements are depicted as individual blocks for clarity, while it is noted that certain elements may be combined or integrated into a single device or functional element, as desired. Mobile communication device 200 is shown including processor 202, PEB 220, memory media 212, display/output elements 222, wireless interface 204, primary battery 206, location sensor 208, PEB battery 210, image sensor 212, and audio sensor 214.

In FIG. 2, processor 202 may be configured to access memory media 212 to retrieve executable instructions and/or to read/write data via a common bus (not shown in FIG. 2). Processor 202 may similarly be configured to access and/or control other functional elements shown in FIG. 2 or included in other embodiments of mobile communication device 200. Memory media 212 are depicted including PEB mobile program 218 and forensic data 216. PEB mobile program 218 may represent executable instructions for responding to a PEB event. Forensic data 216 may represent data collected and retained by mobile communication device 200 during a PEB event, such as images, audio data, location data, other types of sensor data, and/or event indications.

As shown in FIG. 2, PEB 220 may be a physical button or switch on an external surface of mobile communication device 200, and may be configured, along with additional circuitry (not shown in FIG. 2 for clarity) to initiate a PEB event and related processing, as described herein. In certain embodiments, PEB 220 may be a physical button that is at a height different than surrounding physical buttons (i.e., recessed or elevated) or otherwise may contain some physical attribute or be located on mobile communication device 200 in such a manner so as to permit user 102 to readily locate PEB 220. It is noted that in other embodiments, PEB 220 may be a virtual element, such as a button or option accessible via display/output element(s) 222. It is further noted, that PEB 220 may be a dedicated button or switch on mobile communication device 200 for initiating a PEB event or may be selectively configured from buttons or switches on mobile communication device 200 having functionality in addition to initiating a PEB event and which when activated for a designated duration or in a defined pattern will initiate a PEB event.

Mobile communication device 200, as depicted in FIG. 2, further includes display/output element(s) 222, which may represent various types of components for interacting with a user of mobile communication device 200. An output element included in display/output element(s) 222 may represent a device for providing signals or indications to the user, such as loudspeakers for generating audio signals. A display/output element(s) 222 may include a display device, which may be implemented as a liquid crystal display screen, a computer monitor, a television, a touch screen device, or the like. Display/output element(s) 222 may accordingly comply with a display standard for the corresponding type of display. Standards for computer monitors include analog standards such as video graphics array (VGA), extended graphics array (XGA), etc., or digital standards such as digital visual interface (DVI) or high-definition multimedia interface (HDMI), among others. A television display may comply with standards such as NTSC (National Television System Committee), PAL (Phase Alternating Line), or another suitable standard.

Also in FIG. 2, wireless interface 204 may enable mobile communication device 200 to communicate via wireless network 106. Wireless interface 204 may represent an analog or digital wireless interface supporting a cellular architecture. In certain embodiments, mobile communication device 200 may function as a cellular telephone using service provided by wireless network provider 108, and may include additional telephony functions, such as access to voice mail, a list of telephone contacts, text messaging, email, multimedia messaging, among others. In some embodiments, wireless interface 204 may provide wireless network and/or cellular phone functionality. Examples of wireless networks include wireless local area networks (LAN), metropolitan area networks (MAN), personal area networks (PAN), and other networks covered by IEEE 802 standards. Examples of cellular networks include the Global System for Mobile Communications (GSM) and code division multiple access (CDMA), and variations thereof, among others.

Included in FIG. 2 is primary battery 206, which may represent a main power source for mobile communication device 200. Primary battery 206 may be externally accessible for recharging and/or removal or replacement, as desired. During a PEB event, primary battery 206 may become unavailable. For example, a malicious attacker of user 102 may forcibly remove primary battery 206. In certain instances, primary battery 206 may be depleted when user 102 experiences a PEB event and desires to activate PEB 220. When primary battery 206 is unavailable during a PEB event, mobile communication device 200 may be configured to switch power sources to PEB battery 210. In various embodiments, PEB battery 210 may be an embedded component that is not externally accessible. PEB battery 210 may be located on the same charging circuit as primary battery 206, such that PEB battery 210 remains charged during normal operation of mobile communication device 200 and is available to provide power in case of a PEB event.

In FIG. 2, an exemplary embodiment of mobile communication device 200 is shown including three (3) sensors: location sensor 208, image sensor 212, and audio sensor 214. In other embodiments, mobile communication device 200 may include other sensors (not shown in FIG. 2), such as biometric sensors, temperature sensors, pressure sensors, chemical sensors, etc. In various embodiments, mobile communication device 200 may further be configured to operate with sensors via local wireless communication link, such as may be provided by wireless interface 204. It is noted that forensic data 216 may include data acquired by sensors included in mobile communication device 200. Location sensor 208 may be a sensor for measuring a location of mobile communication device 200. Location sensor 208 may employ any of a variety of means for location measurement, such as accelerometers, gyroscopes, or magnetic instruments, etc. In certain embodiments, location sensor 208 is a global-positioning system (GPS) receiver and is configured to generate GPS signals and/or data representing a location of mobile communication device 200. Image sensor 212 may represent an imaging device included with mobile communication device 200, such as a camera or a video camera. Audio sensor 214 may represent an audio input device, such as a microphone.

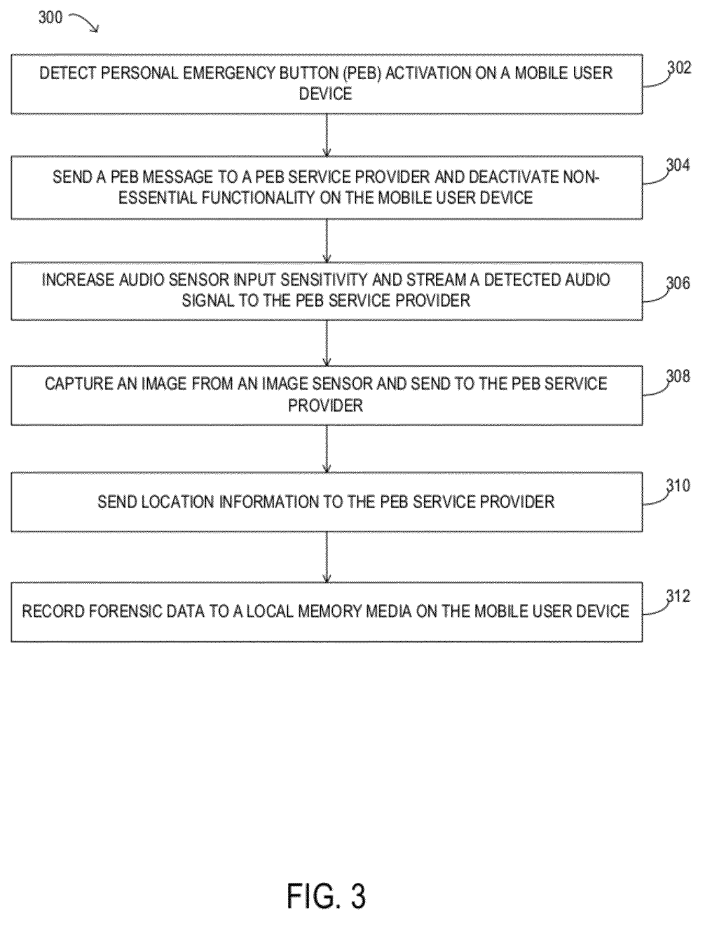

Turning now to FIG. 3, a flow chart describing selected elements of an embodiment of method 300 for personal emergency communication is shown. It is noted that, in certain embodiments, PEB mobile program 218 (see FIG. 2) may execute method 300. In various embodiments, operations shown in method 300 may be omitted or rearranged, as desired. Activation of a PEB may be detected on a mobile user device (operation 302). In one embodiment, activation may be detected when the PEB is continuously activated for three seconds. In other embodiments, activation may be detected when the PEB is continuously activated for more or less than three seconds. In further embodiments, activation of a PEB may be selectively configurable to a desired activation pattern of one or more buttons on the communications device for selectively configurable durations or may be conducted by way of voice command. A PEB message may be sent to a service provider and non-essential functionality on the mobile user device may be deactivated (operation 304). The PEB message may include an identity of a user operating the mobile user device. Non-essential functionality may include functionality that is not pertinent to a PEB event initiated by the activation of the PEB in operation 302. Audio sensor input sensitivity may be increased and a detected audio signal may be streamed to the service provider (operation 306). An image from an image sensor may be captured and sent to the PEB service provider (operation 308). Location information may be sent to the PEB service provider (operation 310). Forensic data may be recorded to a local memory media on the mobile user device (operation 312).

Referring now to FIG. 4, a block diagram illustrating selected elements of an embodiment of a computing device 400 is presented. Computing device 400 may be operated by service provider 110 (see FIG. 1) to provide PEB services. In the embodiment depicted in FIG. 4, device 400 includes processor 401 coupled via shared bus 402 to storage media collectively identified as memory media 410.

Device 400, as depicted in FIG. 4, further includes network adapter 420 that interfaces device 400 to a network (not shown in FIG. 4). In embodiments suitable for use in PEB service deployment, device 400, as depicted in FIG. 4, may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

Device 400 is shown in FIG. 4 including display adapter 404 and further includes a display device or, more simply, a display 405. Display adapter 404 may interface shared bus 402, or another bus, with an output port for one or more displays, such as display 405. Display 405 may be implemented as a liquid crystal display screen, a computer monitor, a television or the like. Display 405 may accordingly comply with a display standard for the corresponding type of display. Standards for computer monitors include analog standards such as VGA, XGA, etc., or digital standards such as DVI or HDMI, among others. A television display may comply with standards such as NTSC, PAL, or another suitable standard.

Memory media 410 encompasses persistent and volatile media, fixed and removable media, and magnetic and semiconductor media. Memory media 410 is operable to store instructions, data, or both. Memory media 410 as shown includes sets or sequences of instructions, namely, an operating system 412, PEB server application 414, and user emergency data 416, as mentioned previously herein. Operating system 412 may be a UNIX or UNIX-like operating system, a Windows® family operating system, or another suitable operating system.

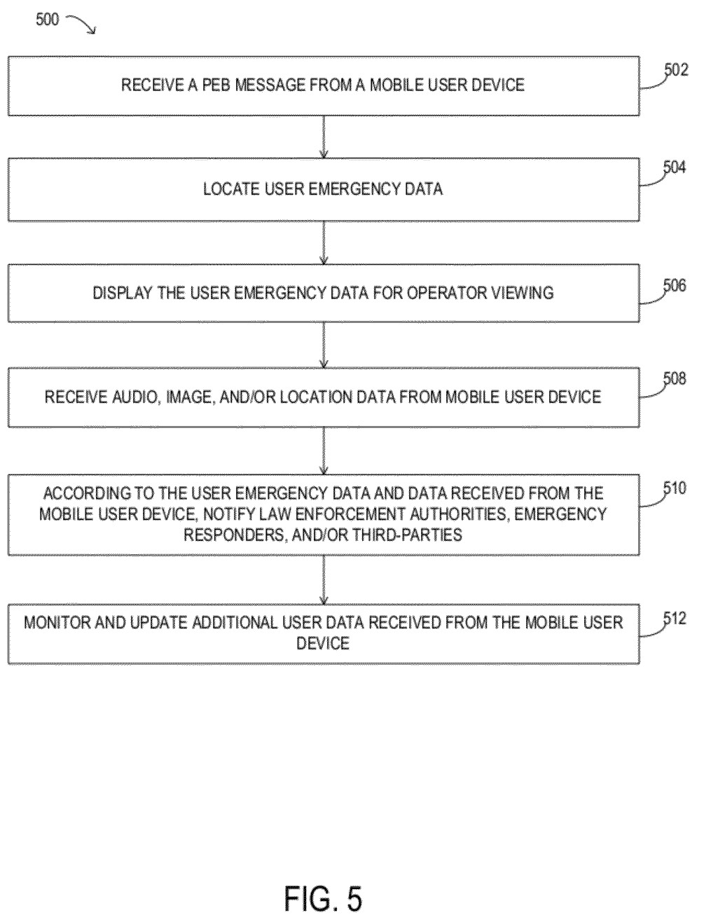

It is noted that in some embodiments device 400 represents a computing device used by service provider 110, shown in FIG. 1. In some cases, PEB server application 414 may be configured to provide functionality described in method 500 (see FIG. 5).

Turning now to FIG. 5, a flow chart describing selected elements of an embodiment of method 500 for providing PEB services is shown. Although method 500 is described with respect to a single user and a single mobile user device, it will be appreciated that method 500 is applicable for providing PEB services to a large number of clients (i.e., users and their respective mobile user devices). Certain operations depicted in method 500 may be omitted or rearranged, as desired.

A PEB message may be received from a mobile user device (operation 502). The PEB message may indicate that a user associated with the mobile user device has initiated a PEB event. The PEB message may further include an identity for the user. User emergency data may be located (operation 504). The user emergency data may be displayed for operator viewing (operation 506). The operator may be charged with handling the PEB event for the user. Audio, image, and/or location data may be received from the mobile user device (operation 508). According to the user emergency data and data received from the mobile user device, law enforcement authorities, emergency responders, and/or third-parties may be notified (operation 510). Additional user data received from the mobile user device may be monitored and updated (operation 512).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method of personal emergency communication, comprising:
detecting activation of a personal emergency button (PEB) at a mobile communication device associated with a user;
sending a PEB message to a PEB service provider via a wireless interface included in the mobile communication device, wherein the PEB message includes an identifier associated with the user; and
deactivating at least a portion of the mobile communication device.

2. The method of claim 1, further comprising:
sending, to the PEB service provider, a global-positioning system coordinate associated with the mobile communication device.

3. The method of claim 1, further comprising:
collecting forensic data at the mobile communication device, the forensic data including at least one of: image data, audio data, and location information.

4. The method of claim 3, further comprising:
forwarding the forensic data to the PEB service provider.

5. A mobile communication device for personal emergency communication, comprising:
a processor;
a personal emergency button (PEB);
a primary battery;
a secondary battery;
a wireless interface;
a location sensor; and
memory media accessible to the processor, including processor executable instructions to:
detect activation of the PEB; and
send a PEB message to a PEB service provider via the wireless interface, wherein the PEB message includes an identifier associated with a user of the mobile communication device,
wherein the mobile communication device is configured to use the secondary battery as a power source when the primary battery is unavailable.

6. The mobile communication device of claim 5, wherein the PEB message includes location information provided by the location sensor.

7. A service for personal emergency communication, comprising:
receiving a personal emergency button (PEB) message from a mobile communication device via a wireless interface included in the mobile communication device, wherein the PEB message includes an identifier associated with a user of the mobile communication device;
receiving location information associated with a location of the mobile communication device;
retrieving, using the identifier, user emergency data for the user;
according to the user emergency data, notifying at least one of: law enforcement authorities, emergency responders, and third-parties that the user is experiencing an emergency at the location of the mobile communication device.

8. The service of claim 7, further comprising:
prior to receiving the PEB message:
registering the user for PEB services; and
generating the user emergency data based on user input from the user.
